(19) United States
(12) Patent Application Publication
(10) Pub. No.: US 2005/0181098 A1
(43) Pub. Date: Aug. 18, 2005

(54) Method and apparatus for cutting a circile in the center of a pizza

(76) Inventor: Roland Wescott Montague, North Saanich (CA)

Correspondence Address: Roland Wescott Montague, 8915 Lochside Drive, North Saanich, BC, V8L 1N1, CA

(21) Appl. No.: 11/052,316

(22) Filed: Feb. 8, 2005

Related U.S. Application Data
(60) Provisional application No. 60/544,073, filed on Feb. 13, 2004.

(51) Int. Cl. A23G 3/00

(52) U.S. Cl. 426/94

(57) ABSTRACT

A method of cutting an outline of an inner circular piece in the center of a pizza then further dividing the resulting outer piece into truncated wedges results in improved retention of pizza toppings on the tip of the wedge during separation from the rest of the pizza. Brand strengthening will occur if the inner piece is instead cut into a shape resembling the company's trademark. As well, apparatus similar to a cookie cutter with a strengthened and sharpened blade is disclosed.

### CROSS REFERENCE TO RELATED APPLICATIONS

This application claims the benefit of PPA Ser. No. 60/544,073, filed 2004 Feb. 13 by the present inventor.

### FEDERALLY SPONSORED RESEARCH

Not Applicable

### SEQUENCE LISTING OR PROGRAM

Not Applicable

### BACKGROUND OF THE INVENTION

The present invention relates to pizza, and more specifically to a method of cutting a pizza, as well as tools to perform the cutting.

Cutting a round pizza into wedges, defined by radial lines emanating from its center, is a standard way of preparing a pizza for consumption. A wedge may become very narrow at the tip when a pizza is cut into many pieces, such as 8 or 12. During eating, it is difficult to hold a narrow wedge because the tip will typically droop under the weight of the cheese and toppings, such as meat and vegetables. The drooping effect is further exaggerated when the shell, namely crust, in the center of the pizza is not crispy or is very thin.

When a person removes a wedge from the pizza, separating the tips of the wedges from each other becomes very challenging. Typically, the cheese and toppings on the tips of both wedges adhere to one of the wedges, resulting in no cheese or toppings on the tip of the other wedge.

U.S. Pat. No. 5,962,050 issued in the name of Adashek teaches a method of preparing pizza dough before toppings are added such that a separate inner piece with additional exposed crust is formed to the benefit of customers who enjoy the taste of crust. However, the added inner crust may be perceived by other customers as having low nutritional value and are therefore likely to feel cheated out of otherwise entitled toppings. Additional complications in controlling the free-floating inner piece arises when attempting to place the two part pizza in an oven for final cooking.

There remains a need for a method that helps prevent the loss of cheese and toppings at the tip of a wedge of pizza. In addition, there remains a need for tools to carry out the method.

### BRIEF SUMMARY OF THE INVENTION

Cutting a pizza into pieces resembling a wagon-wheel, such as one small circular piece in the center and the remaining pieces outlined by the spokes of the wheel, helps prevent the loss of cheese and toppings near the tip of the outside pieces by eliminating the pointed tip region.

In addition, the small circular piece in the center of the pizza may be further cut into a small number of wedges, such as four, thereby maintaining a large angle resulting in a strong tip that will retain toppings.

Alternately, the mentioned small circular piece in the center of the pizza may instead resemble an arbitrary shape, such as a polygon, peanut shape, or a shape similar to a company logo or design.

A novel tool, similar to a cookie cutter, may be operated to cut the outline of the piece in the center, and a standard straight knife, such as a cleaver, may be operated to cut the resulting outer ring into truncated wedge pieces.

A novel curved knife, similar to a very large curved wood-working chisel or gouge, may be operated a number of times to cut a small circular outline in the center of a pizza.

### BREIF DESCRIPTION OF THE DRAWINGS

In drawings which help illustrate the present invention:

FIG. 1 shows a plan view of a pizza cut into standard wedges;

FIG. 2 shows a plan view of one wedge;

FIG. 3 shows a plan view of a pizza cut with a circular piece in the center;

FIG. 4 shows a plan view of a resulting truncated wedge;

FIG. 5 shows a pizza with the circular piece in the center further cut into four;

FIGS. 6A to 6C shows alternate profiles other than a circle cut into the center of a pizza;

FIG. 7A shows the front elevational view of an outline cutting tool;

FIG. 7B shows the bottom plan view of the outline cutting tool;

FIG. 7C shows an isometric view of the outline cutting tool;

FIG. 8A shows an isometric view of an alternate outline cutting tool;

FIG. 8B shows a section view of the alternate outline cutting tool;

FIG. 9A shows the front elevational view of an outline cutting knife;

FIG. 9B show an isometric view of the outline cutting knife;

FIG. 9C shows the bottom view of the outline cutting knife;

FIG. 9D show the bottom view of an alternate outline cutting knife;

In all figures, like reference numerals represent the same or identical components of the present invention.

### DETAILED DESCRIPTION OF THE INVENTION

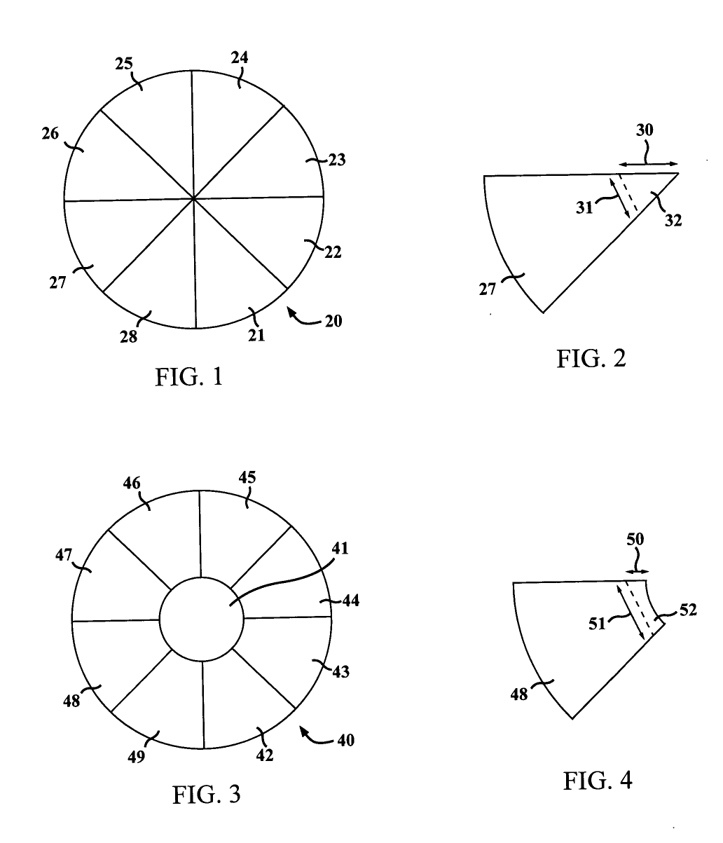

After a pizza 20 is baked in an oven, it is desirable to cut it into manageable pieces that can be eaten without additional utensils or tools; therefore, a pizza is typically cut into wedges 21, 22, 23, 24, 25, 26, 27, 28 as shown in FIG. 1.

A resulting wedge 27, as shown in FIG. 2, will have a narrow tip if the pizza is cut into eight or more pieces. A tip is described as narrow when the length 30 of the tip is greater than the width 31 of the tip. If the force required to tear the pre-cut cheese along the length 30 is greater than the strength of the cheese spanning the width 31, then the toppings in the tip region 32 of both pieces often stay on only one of the two pieces being separated. One may decrease the force required to tear the pre-cut cheese by re-cutting, thereby, easing the separation of the wedges 27 and all appropriate toppings. Alternately, one may use their fingers on the length 30 of connecting cheese to help separate the desired wedge from the remaining pizza.

In a method of the present invention, as shown in FIG. 3, a pizza is cut into pieces 40 resembling a wagon-wheel by cutting the outline of one small circular piece 41 near the center and then cutting the remaining outer ring into eight or more pieces 42, 43, 44, 45, 46, 47, 48, 49 with cut lines on the radial spokes of the wagon-wheel. The order of cutting may be reversed or performed at one time by a large tool. A resulting piece 48 from the outer ring resembling a truncated wedge, as shown in FIG. 4, has a length 50 of the tip that is shorter than the width 51 of the tip. Therefore, the force required to tear the pre-cut cheese along the length 50 is less than the strength of the cheese spanning the width 51, resulting in the toppings in the tip region 52 remaining intact with the appropriate piece 48 of pizza. Due to being unique, the piece 41 in the center may also be regarded as having more value than the others, thus instilling competitiveness and fun, and may be used as a marketing platform.

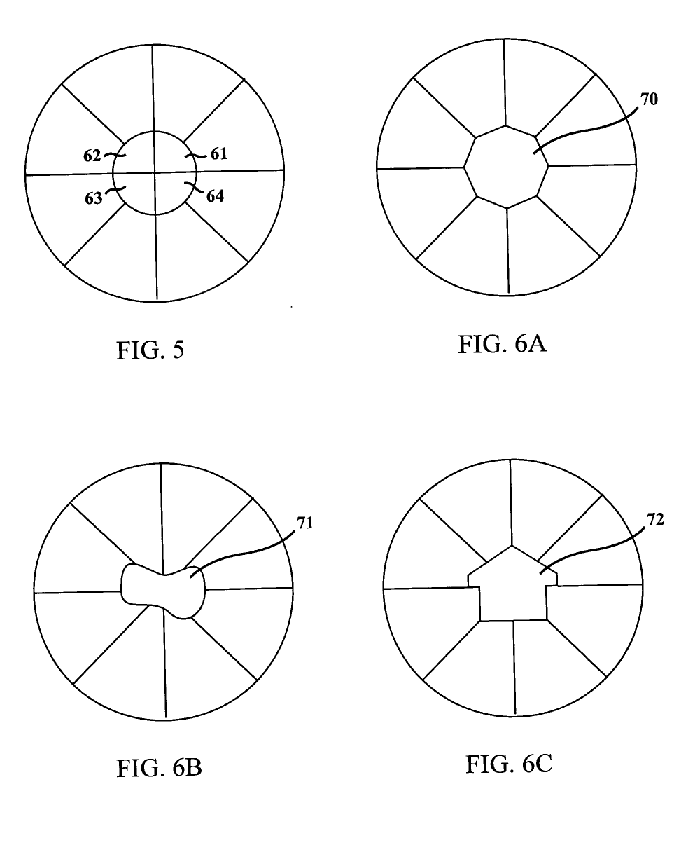

In addition, the piece 41 in the center may be cut into a small number of wedges 61, 62, 63, 64, as shown in FIG. 5, resulting in the width being greater than the length, and therefore maintaining the structural strength of the tips of the wedges.

Alternately, the mentioned outline of the small circular piece 41 in the center of the pizza may instead be cut into an arbitrary profile or shape, such as a polygon 70, peanut shape 71, or a shape 72 that resembles a company logo or design, as shown in FIGS. 6A to 6C. These shapes 70, 71, 72 may be further cut into manageable sizes if necessary.

The present invention is not limited to cutting the pizza after it is cooked. A previously prepared ready-to-bake pizza may be cut before or after it is frozen. During baking, the cheese will melt and rejoin across the cut lines making the lines difficult to see; however, the pieces 21, 22, 23, 24, 25, 26, 27, 28, 41, 42, 43, 44, 45, 46, 47, 48, 49 may still be separated since the toppings and under lying shell, namely crust, have been cut. The mentioned pieces may not be completely cut through the underlying crust in a number of places, as well as a portion of the outer most crust, to keep the pieces together while the pizza is handled and to help prevent the cheese from melting through the cut lines onto the oven rack below. To assist in separation of the pieces and appearance of cut lines, high temperature plastic, or aluminum foil dams may be inserted in the cut lines during, or after, cutting. The mentioned dams are left in place during baking to prevent the cheese from melting over the cut lines. Alternately, an edible substance that inhibits the rejoining of cheese across the cut lines may be applied to the cut lines after or during cutting.

In another method of the present invention, it is conceived of asking a customer to specify a particular cutting method by referring to depictions thereof in a graphical menu during the ordering cycle at a restaurant or over the phone or internet.

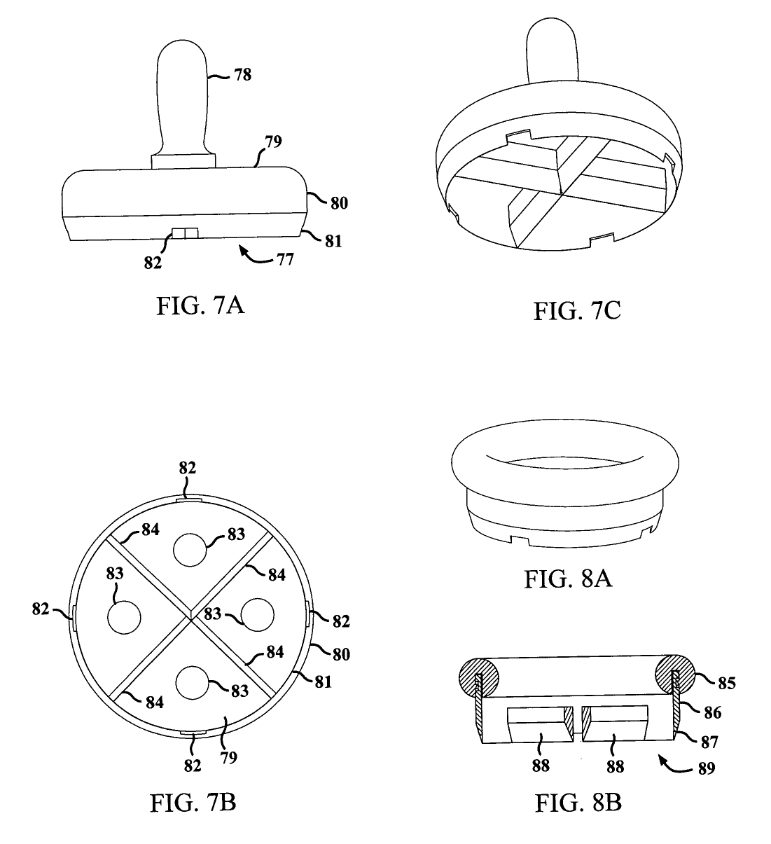

In an embodiment of the present invention, a novel outline cutting tool, similar to a cookie cutter, may be used to cut the outline of the piece 41, 70, 71, 72 in the center of a pizza, and a standard knife, such as a cleaver, may be used to cut the resulting outer ring into pieces. As shown in FIGS. 7A, 7B and 7C, the outline cutting tool 77 comprises a handle 78 fastened to a top portion 79 and a cylindrical flange 80 terminating in a cutting blade 81 formed into a profile, such as a circle of three inch diameter or other arbitrary shape. The outline cutting blade 81 may comprise notches 82 or gaps to prevent local cutting of the underlying pizza crust, thereby preventing the inner piece 41, 70, 71, 72 from remaining inside the outline cutting tool 77 while the tool 77 is removed from the pizza after cutting. The top portion 79 is provided with suitable air holes 83. The outline cutting tool 77 may further comprise radial cutting blades 84 internal to the profile cutting blade 81. These internal cutting blades 84, fastened to the handle 78, the top portion 79, or the profile cutting blade 80, 81; cut the piece 41, 70, 71, 72 in the center of the pizza into smaller, more manageable, pieces 61, 62, 63, 64. FIGS. 8A and 8B show an alternate embodiment of an outline cutting tool 89 comprising a handle 85, a cylindrical wall 86 terminating in a profile cutting blade 87, and plural radial internal cutting blades 88. The mentioned handles 78, 85 may be fabricated from wood, steel, aluminum, rubber, or plastic type materials, and the cutting blades 81, 84, 87, 88 may be fabricated from plastic, steel, or aluminum. The outline cutting tool 77, 89 may further comprise a temporary or permanent information card, sticker, or marking comprising the word “pizza”.

A standard cookie-cutter or other tool comprising an arc or circular cutting edge, that further comprises an information card, tag, label, marking, scribing, box, or booklet that comprises the word “pizza” or other words, pictures, or phases describing a pizza, such as “cheese-pie”; is understood to be within the scope and spirit of the present invention.

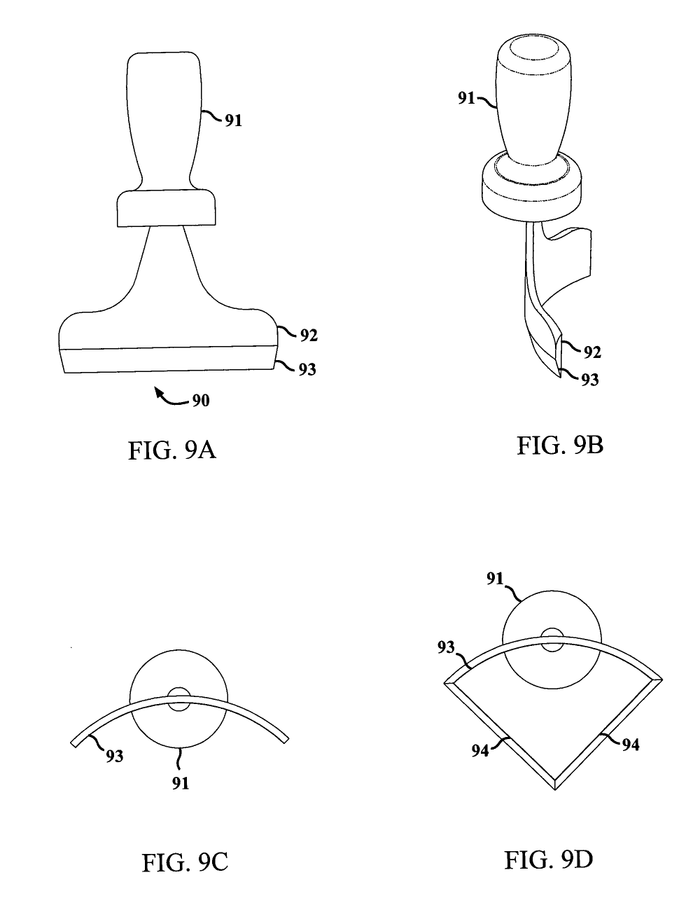

In another embodiment of the present invention, a novel curved knife resembling a portion of a circle, such as a quarter or a third, may be operated a number of times to cut the outline of the mentioned small circular piece 41 in the center of a pizza. As shown in FIGS. 9A, 9B, and 9C, the outline cutting knife 90 comprises a handle 91 fastened to a supporting member 92 terminating in a cutting blade 93 formed into a portion of a cylinder, such as an arc spanning ninety degrees of a three inch diameter circle, with an axis parallel to the cutting direction of the blade 93 and perpendicular to the cutting edge. Similarly in FIG. 9D, the supporting member 92 and circular cutting blade 93 may comprise one or more additional straight cutting blades 94 that extend to the center point of the arc, thereby, cutting the small circular piece 41 in the center of a pizza into wedges at the same time as cutting the outline of the circle. The mentioned handle 91 may be fabricated from wood, steel, aluminum, rubber, or plastic type materials, and the cutting blade 92, 93, 94 may be fabricated from plastic, steel, or aluminum. The outline cutting knife 90 may further comprise a temporary or permanent information card or sticker comprising the word “pizza”.

Those skilled in the art may make various modifications to the methods and embodiments described herein without departing from the spirit of the present invention. The scope of the invention is set forth in and is to be only limited by the following claims.

1. A food product, comprising:
a substantially planar outer shell defining a peripheral outer edge and a peripheral inner edge, wherein the peripheral inner edge defines an opening; and
a substantially planar inner shell separate from the outer shell and defining a peripheral outer edge, wherein the outer edge of the inner shell is laterally positioned from the inner edge of the outer shell and is sized and configured so as to enable the inner shell to be received within the opening defined by the outer shell, wherein the outer edge of the inner shell is in intimate contact with the inner edge of the outer shell, whereby further division of said outer shell provides truncated wedges which are more susceptible to retaining toppings thereon.

2. The food product of claim 1 wherein the inner edge of the outer shell has a circular profile.

3. The food product of claim 1 wherein the inner edge of the outer shell has a profile resembling a trademark.

4. A method for retention of pizza toppings on a slice comprising:
(a) providing a substantially assembled pizza comprising a shell, and a plurality of toppings; and
(b) cutting an outline of an inner piece substantially through said pizza and substantially in the center thereof, whereby additional cutting of the resulting outer piece provides truncated wedges which are more susceptible to retaining toppings thereon.

5. The method of claim 4 wherein said pizza is substantially cooked to the state of serving.

6. The method of claim 4 wherein said pizza is in any state prior to placement in an oven for final cooking and serving, whereby a frozen pizza manufacturer may pre-cut the outline of said inner piece before or after freezing said pizza.

7. The method of claim 6 wherein the outline of said inner piece further comprises a plurality of connecting means for preventing separation of said inner piece from the remaining said pizza during handling.

8. The method of claim 4 further comprising cutting a plurality of radial cuts from said outline of said inner piece to the peripheral outer edge of said pizza, such that the resulting outer pieces have the shape of truncated wedges.

9. The method of claim 8 wherein the step of cutting said plural radial cuts precedes the step of cutting said outline of said inner piece.

10. The method of claim 4 wherein said outline of said inner piece has a circular shape.

11. The method of claim 4 wherein said outline of said inner piece has a shape resembling a trademark.

12. A pizza cutter for cutting an outline of an inner piece in a pizza, said pizza cutter comprising:
a cutting edge having a nonlinear profile normal to the cutting direction; and
a support means for supporting said cutting edge and terminating thereof; and
a handle means for a user to hold and manipulate said pizza cutter; and
a communication means for implying the function of said pizza cutter being that of cutting a pizza;
wherein said handle means is fastened to said support means, and said support means is of sufficient strength to enable said pizza cutter to perforate a cooked pizza,
whereby thrusting said pizza cutter into said cooked pizza results in a perforation having a shape of said nonlinear profile.

13. The pizza cutter of claim 12 wherein said nonlinear profile having a shape of a segment of a circle, whereby repeated positioning and thrusting results in a circular inner piece of pizza near the center of said cooked pizza.

14. The pizza cutter of claim 12 wherein said nonlinear profile having a shape of a circle.

15. The pizza cutter of claim 14 wherein said support means, substantially near said cutting edge, is conical in shape with an axis substantially parallel to said cutting direction, such that the resulting inner piece of pizza is not retained within said pizza cutter.

16. The pizza cutter of claim 14 wherein said cutting edge having a plurality of non-cutting notches, whereby the resulting uncut sections of pizza prevent retention of the resulting inner piece of pizza within said pizza cutter.

17. The pizza cutter of claim 14 further comprising one or more inner cutting blades such that the resulting inner circular piece of pizza is further divided.
